(19) United States
(12) Patent Application Publication
(10) Pub. No.: US 2007/0058205 A1
(43) Pub. Date: Mar. 15, 2007

(54) Image formation apparatus and image processing method therefor

(75) Inventor: Kiyoshi Une, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/333,172

(22) Filed: Jan. 18, 2006

(30) Foreign Application Priority Data
Sep. 14, 2005 (JP) 2005-266964

(51) Int. Cl. H04N 1/409

(52) U.S. Cl. 358/3.26; 358/3.21

(57) ABSTRACT

An image formation apparatus which receives a job and forms an image including an object specified with printing data included in the received job, and which includes a job receiving section which receives a job, an image development section which identifies the object to be formed on the basis of the printing data included in the job received by the job receiving section, and an image processing selection section which identifies a tendency of banding occurring in an output image on the basis of a type of the job received by the job receiving section and a type of the object identified by the image development section, and selects an image processing according to the identified tendency.

### BACKGROUND OF THE INVENTION

1. Field of the Invention

The present invention relates to an image formation apparatus and an image processing method therefor, and particularly relates to an image formation apparatus which minimizes the occurrence of banding in an image to be outputted, and an image processing method therefor.

2. Description of the Related Art

The image quality of an image outputted by an image formation apparatus, such as a printer, or the like, tends to be improved. Examples of the art which improve the image to be outputted include that which changes over the screen by the paper quality (as disclosed in Japanese Patent Application Laid-Open No. 2000-280530, for example), that which changes over the screen by the image magnification (as disclosed in Japanese Laid-Open Publication No. 11-220613, for example), and the like.

However, with the conventional image formation apparatus, the condition determination has been carried out on a single factor, such as the paper quality, the image magnification, or the like, thus there has been a problem that, even under a certain condition which will not involve image quality degradation by the occurrence of banding, or the like, the screen changeover is performed, which may result in the image quality being unavoidably degraded. On the contrary, even under a condition other than the above-mentioned condition, the output image may have had a banding, and thus further improvement has been demanded.

### SUMMARY OF THE INVENTION

An aspect of the present invention provides an image formation apparatus which receives a job and forms an image including an object specified with printing data included in the received job, and which includes a job receiving section which receives a job, an image development section which identifies the object to be formed on the basis of the printing data included in the job received by the job receiving section, and an image processing selection section which identifies a tendency of banding occurring in an output image on the basis of a type of the job received by the job receiving section and a type of the object identified by the image development section, and selects an image processing according to the identified tendency.

Another aspect of the present invention provides an image processing method for an image formation apparatus which receives a job and forms an image including an object specified with printing data included in the received job, in which an image processing selection section identifies a tendency of banding occurring in an output image on the basis of a type of the job and a type of the object, and selects an image processing according to the identified tendency.

### BRIEF DESCRIPTION OF THE DRAWINGS

Embodiments of the present invention will be described in detail based on the following figures, wherein:

FIG. 1 is a block diagram illustrating a functional scheme of the image processing apparatus to which the present invention is applied;

FIG. 2A to FIG. 2C are drawings illustrating the effect which the printing geometry can have on the tendency of the occurrence of banding;

FIG. 3A to FIG. 3C are drawings illustrating the effect which the type of job can have on the tendency of the occurrence of banding;

FIG. 4A and FIG. 4B are drawings illustrating an example of changeover from one screen to another on the number of lines;

FIG. 5A and FIG. 5B are drawings illustrating an example of changeover from one screen to another on the angle;

FIG. 6A and FIG. 6B are drawings illustrating an example of changeover from one screen to another on the growth pattern;

FIG. 7A and FIG. 7B are drawings illustrating an example of changeover from one screen to another on the cell size;

FIG. 8 is a flowchart illustrating the flow of the operation of the screen control section 17;

FIG. 9 is a flowchart illustrating the flow of the screen selection processing in EXAMPLE 1;

FIG. 10 is a table which gives the conditions for selecting a particular screen, and the screen which is selected on those conditions;

FIG. 11 is a flowchart illustrating the flow of the screen selection processing by the screen control section 17 in EXAMPLE 2;

FIG. 12 is a flowchart illustrating the flow of the screen selection processing by the screen control section 17 in EXAMPLE 3;

FIG. 13 is a flowchart illustrating the flow of the screen selection processing by the screen control section 17 in EXAMPLE 3;

FIG. 14 is a flowchart illustrating the flow of the screen selection processing by the screen control section 17 in EXAMPLE 3; and

FIG. 15 is a flowchart illustrating the flow of the screen selection processing by the screen control section 17 in EXAMPLE 3.

### DETAILED DESCRIPTION OF THE INVENTION

Hereinbelow, embodiments of the image processing apparatus and the method pertaining to the present invention will be described in detail with reference to the attached drawings.

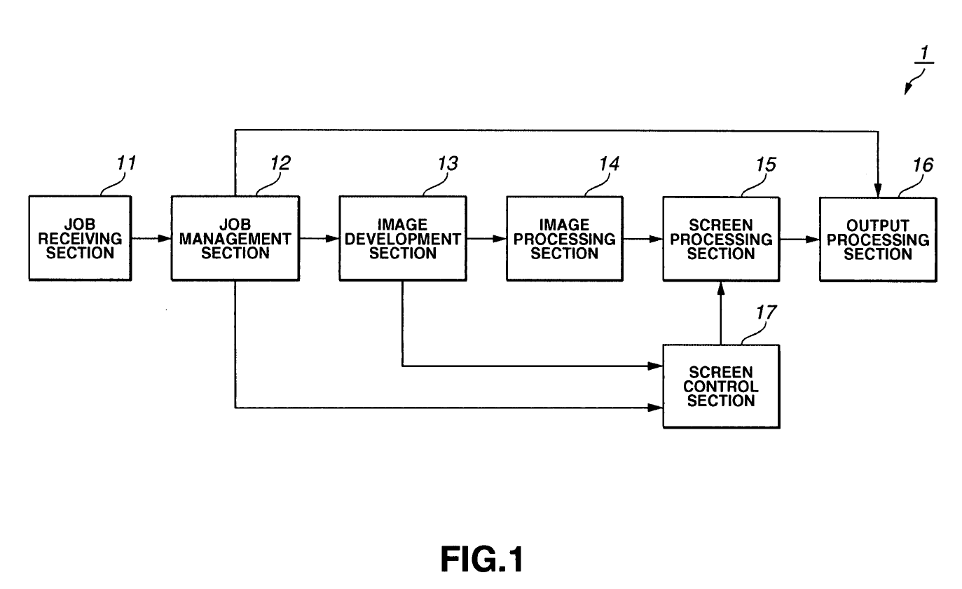

FIG. 1 is a block diagram illustrating the functional scheme of an image formation apparatus to which the present invention is applied. As shown in the same figure, the image formation apparatus 1 is configured to comprise a job receiving section 11, a job management section 12, an image development section 13, an image processing section 14, a screen processing section 15, an output processing section 16, and a screen control section 17.

The job receiving section 11 receives a print job which is sent by an information processing apparatus, such as a personal computer (not shown), or the like. The job management section 12 manages the job which has been received by the job receiving section 11, and implements the job by taking a prescribed procedure. The image development section 13 develops the printing data included in the print job, and generates image data including an object to be printed. The image processing section 14 provides processings, such as various corrections and color conversion, and the like, for the image data which has been generated by the image development section 13. The screen processing section 15 applies a screen to the image data which has been provided with image processings by the image processing section 14, for providing a screen processing. The output processing section 16 forms an image on a paper on the basis of the image data which has been provided with a screen processing in the screen processing section 15, in accordance with an instruction of a job management section 12.

In addition, the screen control section 17 selects the screen to be applied to the image data by the screen processing section 15, on the basis of the type of the job to be implemented by the job management section 12, and the geometry, and the like, of the object to be developed by the image development section 13. In screen selection, the tendency of banding which is to occur in the output image is identified on the basis of the type of the job, and the geometry, and the like, of the object, and a particular screen which corresponds to the identified tendency is selected.

Herein, the tendency of the occurrence of banding will be described. The tendency of the occurrence of banding, i.e., whether banding is easily developed or not depends upon various factors, however, herein, the tendency will be described for plurality of factors.

(1) Printing Geometry

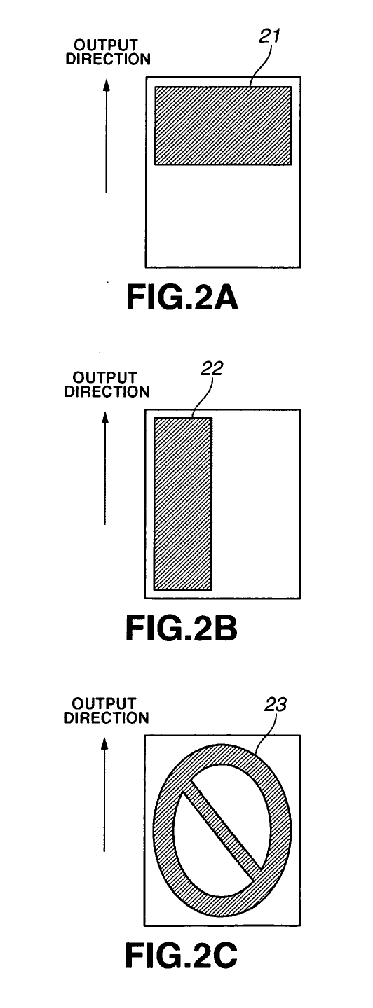

One of the factors which can have an effect on the tendency of the occurrence of banding is the printing geometry. The printing geometry mentioned here includes the size, the position, and the geometry of the object. Banding is generated mainly resulting from the toner being not uniformly deposited on the paper, and mainly provides a stripe occurring in the horizontal scanning direction. Therefore, with an object having a smaller area and that which is shorter in length in the horizontal scanning direction, banding tends to be more difficult to occur (more difficult to be conspicuous). For example, an object 21 as shown in FIG. 2A, and an object 22 as shown in FIG. 2B have approximately the same area, however, the object 22, which is shorter in the horizontal scanning direction (the direction perpendicular to the output direction in the drawing), is difficult to generate banding, as compared to the object 21. In addition, an object 23 as shown in FIG. 2C has approximately the same area as that of the object 21 and the object 22, but it has a complex geometry, resulting in it being shorter than the object 21 in the horizontal scanning direction, and thus the object 23 may be difficult to generate banding, as compared to the object 21.

(2) Object Attribute

Another factor which can have an effect on the tendency of the occurrence of banding is the object attribute. As the object attribute mentioned here, there are three types; the text, the graphic, and the image, and the graphic and the image provide an area fill portion, thus they may easily generate banding, as compared to the text

(3) Coverage and Chroma

Another factor which can have an effect on the tendency of the occurrence of banding is the coverage and the chroma. For the coverage and the chroma, even if the object area is the same, banding tends to easily occur with the coverage being increased, and banding tends to easily occur with the chroma being lowered.

(4) Number of Colors and Density

Another factor which can have an effect on the tendency of the occurrence of banding is the number of colors and the density. For the number of colors and the density, even if the object area is the same, banding tends to easily occur with the number of colors being reduced, and banding tends to easily occur with the number of portions having a uniform density being increased.

(5) Type of Job

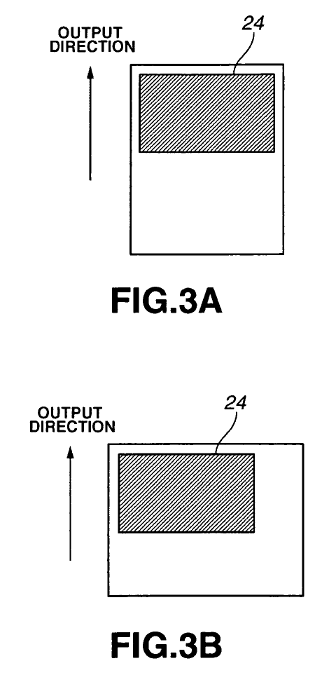

Still another factor which can have an effect on the tendency of the occurrence of banding is the type of job. As the type of job, there are the number of continuous output sheets, the output speed, the paper orientation selected, and the like. For example, even if the object area is the same, the job with which 100 sheets are to be continuously outputted tends to easily generate banding, as compared to the job with which only 1 sheet is to be outputted, and as the output speed is increased, banding tends to occur more easily. In addition, as shown in FIG. 3A and FIG. 3B, even if the same object 24 is to be outputted, the processing speed in outputting with the paper oriented as shown in FIG. 3B is higher than that in outputting with the paper oriented as shown in FIG. 3A, and thus the outputting with the paper oriented as shown in FIG. 3B tends to generate banding more easily.

Next, selection of the screen will be described When the screen control section 17 determines that banding is easily generated, it changes over the screen from that which is ordinarily used, to that with which banding is difficult to be generated, and herein, a few examples of such changeover will be described.

(1) Lowering the Number of Lines

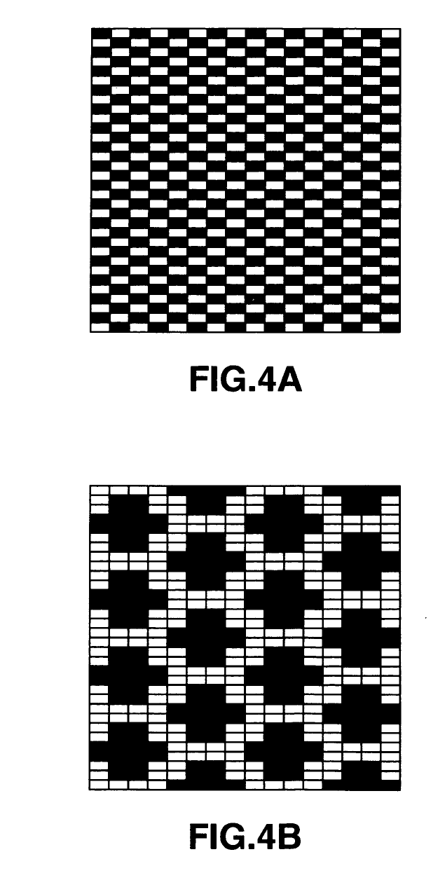

With the number of lines for the screen being decreased, the toner is more stabilized to be more easily deposited, thus by changing over the screen to that with a smaller number of lines, banding is rendered more difficult to occur. Such changeover of the screen is performed by, for example, changing over from the screen with 424 lines as shown in FIG. 4A to that with 106 lines as shown in FIG. 4B.

(2) Changing Angle

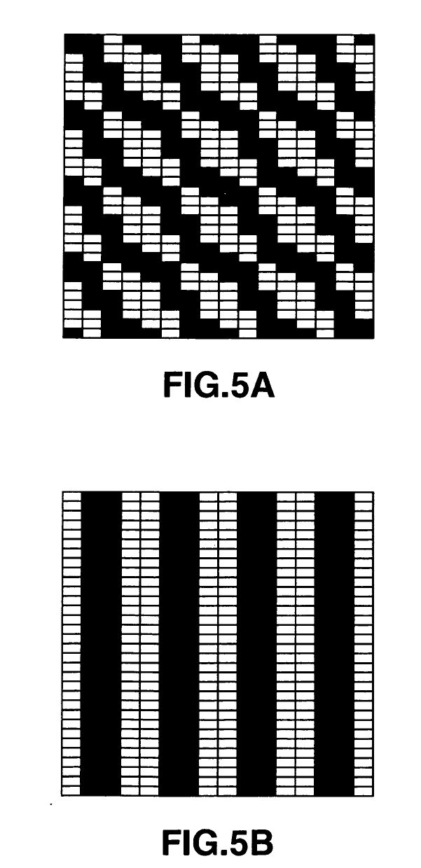

When the angle for the screen is at a multiple of 45 deg, the screen tends to eliminate misregister, and if the angle is at 90 deg, the screen tends to eliminate misregister in the vertical scanning direction. Thereby, rainbow banding, which makes a portion to be gray colored yellowish or bluish, is rendered difficult to occur. Such changeover of the screen is performed by, for example, changing over from the screen for 108 deg as shown in FIG. 5A to that for 90 deg as shown in FIG. 5B.

(3) Changing Growth Pattern

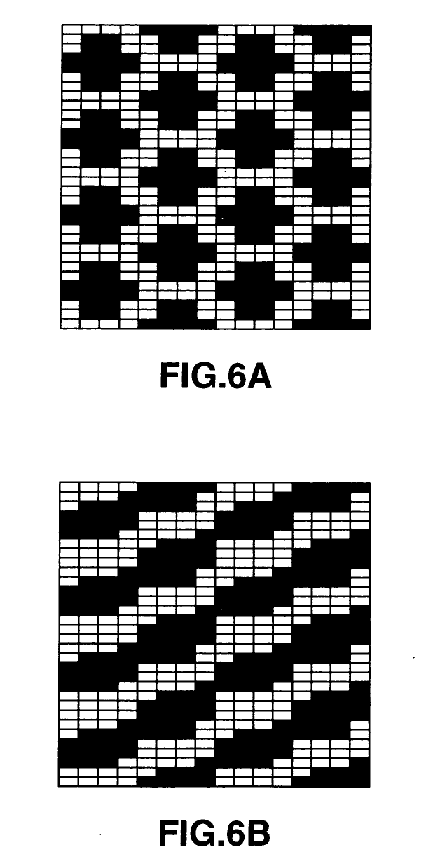

As the dots in the screen are grown, the toner is more easily deposited thereon, being more stabilized. On the other hand, when the dots are grown, the screen tends to cause misregister. However, by changing the growth pattern from the dot concentrated pattern to the line-like one, misregistering is eliminated, rainbow banding being rendered difficult to occur. Such changeover of the screen is performed by, for example, changing over from the dot-concentrated screen as shown in FIG. 6A to the line-like screen as shown in FIG. 6B.

(5) Increasing Cell Size

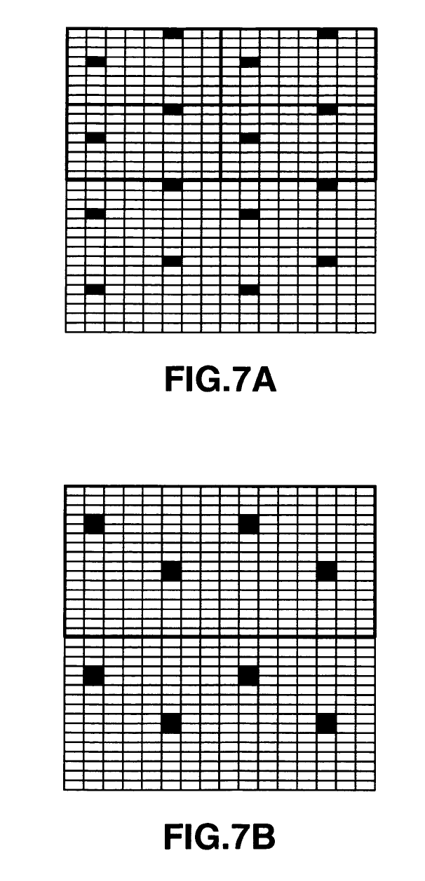

When the cell size of the screen is increased, the highlighted portion, and the like can be reproduced with a smaller number of lines, and as a result, banding can be rendered difficult to occur. Such changeover of the screen is performed by, for example, changing over from the screen having a cell size of “8×8” as shown in FIG. 7A to that with a cell size of “16×16” as shown in FIG. 7B.

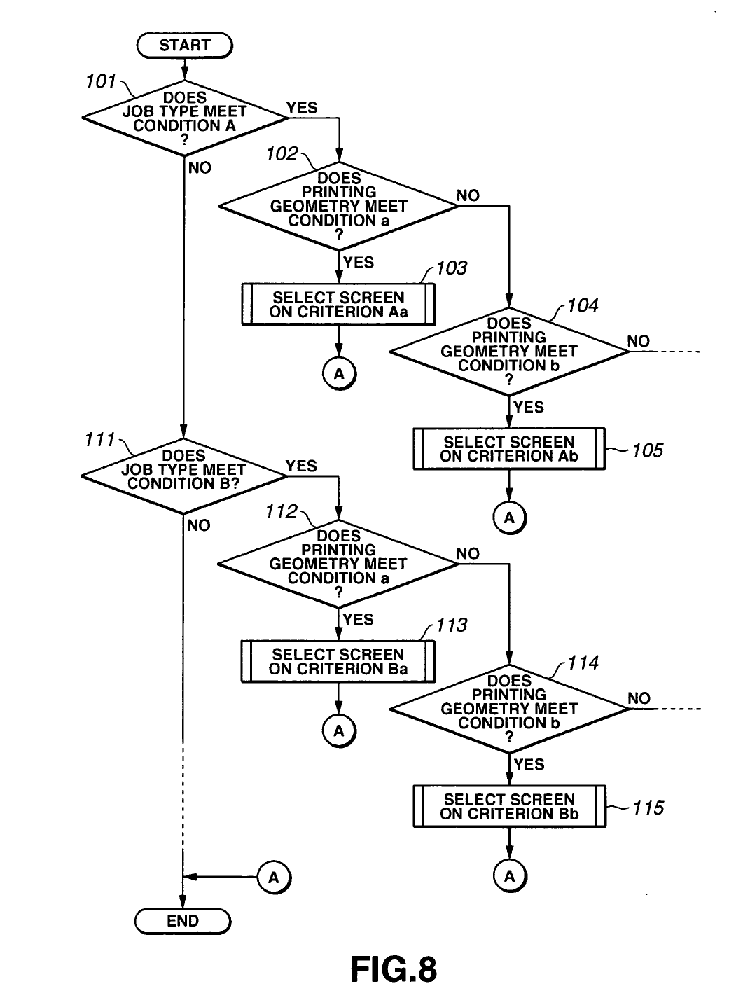

Next, the operation of the screen control section 17 will be described. FIG. 8 is a flowchart illustrating the flow of the operation of the screen control section 17.

When the implementation of the job is started, the screen control section 17 selects the screen to be used in the implementation of the job; specifically, with the type of the job meeting the condition A (YES at step 101), when the printing geometry meets the condition a (YES at step 102), the screen will be selected on the criterion Aa (at step 103); when the printing geometry meets the condition b (NO at step 102, and YES at step 104), the screen will be selected on the criterion Ab (at step 105); and the like, thus the screen is selected on the basis of the type and printing geometry of the job.

Similarly, with the type of the job meeting the condition B (NO at step 101, and YES at step 111), when the printing geometry meets the condition a (YES at step 112), the screen will be selected on the criterion Ba (at step 113); when the printing geometry meets the condition b (NO at step 112, and YES at step 114), the screen will be selected on the criterion Bb (at step 115); and the like, thus the screen is selected on the basis of the type and printing geometry of the job.

The number of conditions (for the type and printing geometry of the job) for selecting the screen is not limited to that as given in FIG. 8, and still more conditions can be utilized. The specific conditions for selecting a particular screen and the screen to be selected on the conditions will be described in the respective EXAMPLES later given. Various relationships between a particular screen and the conditions for selecting the screen, other than those as described in the respective EXAMPLES later given, can be combined as appropriate for use.

### EXAMPLE 1

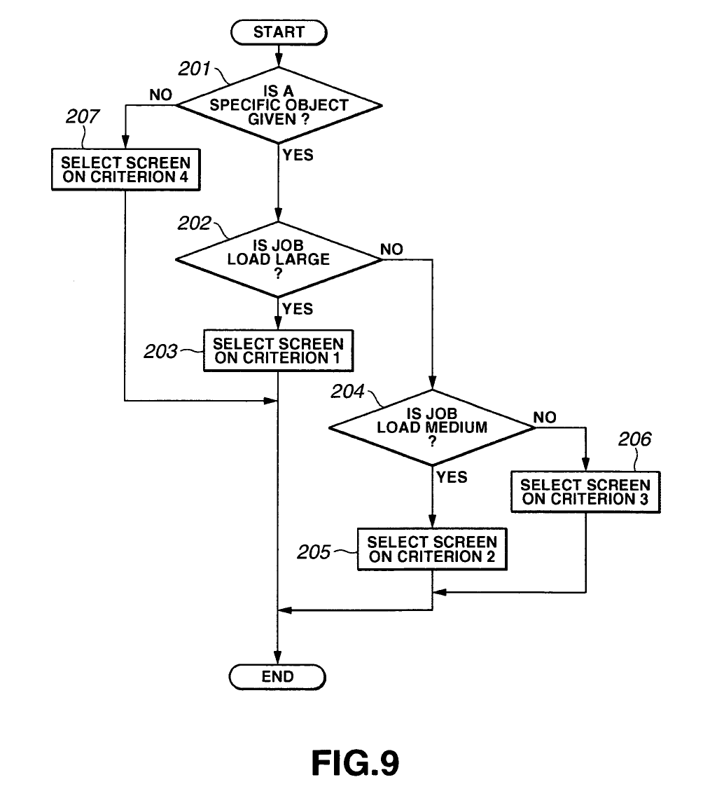

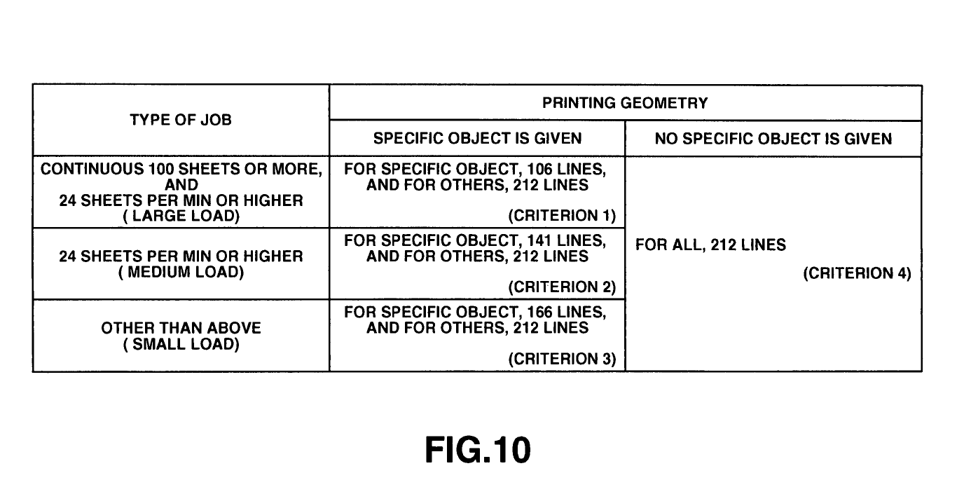

FIG. 9 is a flowchart illustrating the flow of the screen selection processing in EXAMPLE 1, and FIG. 10 is a table which gives the conditions for selecting a particular screen, and the screen which is selected on those conditions.

In the screen selection processing by the screen control section 17, when a specific object, for example, an object which has a length in the lateral direction (horizontal scanning direction) longer than the longer side of the B5 size is given in the page to be outputted (YES at step 201), and the load on the output processing section 16 is large (for example, the job involves a continuous output of 100 sheets or more, and a processing speed of 24 sheets per minute or higher) (YES at step 202), the screen is selected on the criterion 1 as given in FIG. 10. The criterion 1 applies the screen of 106 lines to the specific object portion, and applies the screen of 212 lines to the portions other than that.

In addition, when a specific object is given in the page to be outputted (YES at step 201), and the load on the output processing section 16 is medium (for example, the job involves a processing speed of 24 sheets per minute or higher) (NO at step 202 and YES at step 204), the screen control section 17 selects the screen on the criterion 2 as given in FIG. 10. The criterion 2 applies the screen of 141 lines to the specific object portion, and applies the screen of 212 lines to the portions other than that

In addition, when a specific object is given in the page to be outputted (YES at step 201), and the load on the output processing section 16 is small (NO at step 202 and NO at step 204), the screen control section 17 selects the screen on the criterion 3 as given in FIG. 10. The criterion 3 applies the screen of 166 lines to the specific object portion, and applies the screen of 212 lines to the portions other than that

On the other hand, when no specific object is given in the page to be outputted (NO at step 201), the screen control section 17 selects the screen on the criterion 4 as given in FIG. 10. The criterion 4 applies the screen of 212 lines to all the portions.

### EXAMPLE 2

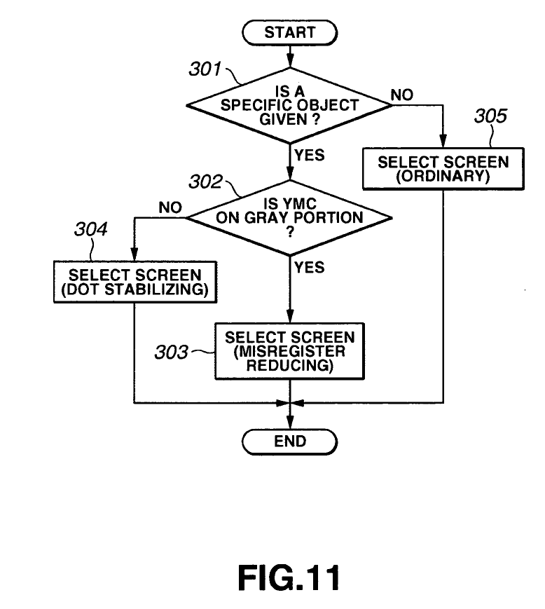

FIG. 11 is a flowchart illustrating the flow of the screen selection processing by the screen control section 17 in EXAMPLE 2.

In the screen selection processing by the screen control section 17, when a specific object, for example, an object which has a length in the lateral direction (horizontal scanning direction) longer than the longer side of the A5 size is given in the page to be outputted (YES at step 301), and the object has a gray portion where the toner of any of Y (yellow), M (magenta), and C (cyan) is deposited (YES at step 302), the screen control section 17 determines that rainbow banding easily occurs, and selects the screen which can minimize the misregister, for example, the screen which has 166 lines, a moderate number of lines, and is of line pattern (at step 303).

In addition, when a specific object is given in the page to be outputted (YES at step 301), and the object has no gray portion, or, if a gray portion is given, any of the Y, M, and C toners is not to be deposited on that gray portion (NO at step 302), the screen control section 17 determines that banding easily occurs, and selects the screen which stabilize the dots, for example, the dot pattern screen which has 106 lines, a low number of lines (at step 304).

On the other hand, when no specific object is given in the page to be outputted (NO at step 301), the screen control section 17 determines that banding is difficult to occur, and selects the ordinary screen, for example, the dot pattern screen which has 212 lines, a high number of lines (at step 305).

### EXAMPLE 3

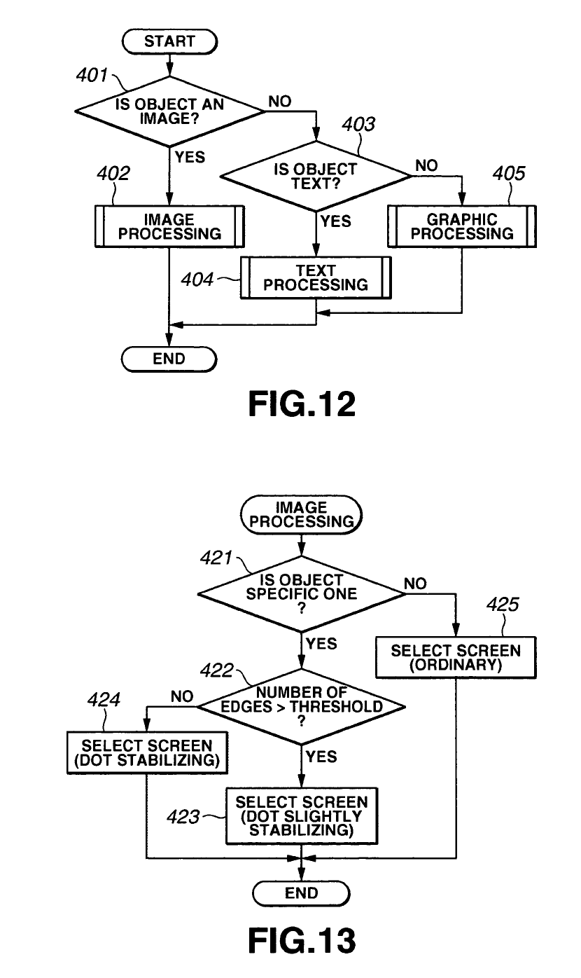

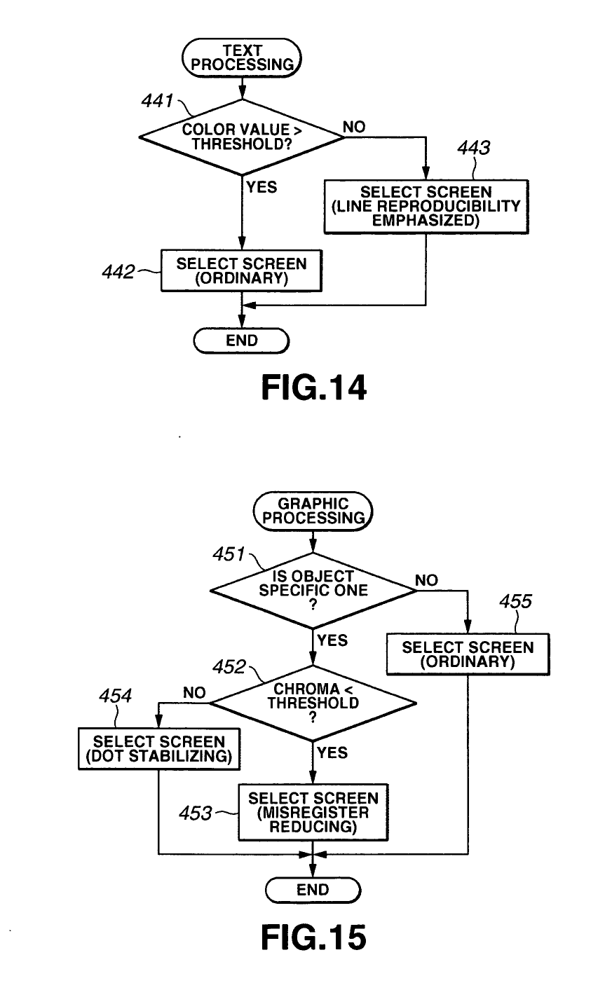

FIG. 12 to FIG. 15 are flowcharts illustrating the flow of the screen selection processing by the screen control section 17 in EXAMPLE 3.

In the screen selection processing by the screen control section 17, when the object to be outputted is an image (YES at step 401), the image processing later described is performed (at step 402), and when the object to be outputted is text (NO at step 401 and YES at step 403), the text processing later described is performed (at step 404). In addition, when the object to be outputted is graphic (NO at step 401 and NO at step 403), the graphic processing later described is performed (at step 405).

In the image processing, when the object is a specific object, for example, an object which has a length in the lateral direction (horizontal scanning direction) longer than the longer side of the A5 size (YES at step 421), and the number of edges for the object is higher than the predetermined threshold value (YES at step 422), the screen control section 17 determines that a slight banding easily occurs, and selects the screen which slightly stabilizes the dots, for example, the dot pattern screen which has 166 lines, a moderate number of lines (at step 423).

In addition, when the object is a specific object (YES at step 421), and the number of edges for the object is equal to or smaller than the predetermined threshold value (NO at step 422), the screen control section 17 determines that banding easily occurs, and selects the screen which stabilizes the dots, for example, the dot pattern screen which has 106 lines, a low number of lines (at step 424).

On the other hand, when the object is not a specific object (NO at step 421), the screen control section 17 determines that banding is difficult to occur, and selects the ordinary screen, for example, the dot pattern screen which has 212 lines, a high number of lines (at step 425).

In addition, in the text processing, when the object has a color value greater than the predetermined threshold value, for example, a color value higher than 75% (YES at step 441), the screen control section 17 determines that banding is difficult to occur, and character break is difficult to be caused, and selects the ordinary screen, for example, the dot pattern screen which has 212 lines, a high number of lines (at step 442).

On the other hand, when the object has a color value equal to or lower than the predetermined threshold value (NO at step 441), the screen control section 17 determines that banding is difficult to occur, but character break is easy to be caused, and selects the screen with which the line reproducibility is emphasized, for example, the line pattern screen which has 424 lines, an extremely high number of lines (at step 443).

In the graphic processing, when the object is a specific object, for example, an object which has a length in the lateral direction (horizontal scanning direction) longer than the longer side of the A5 size (YES at step 451), and the chroma for the object is lower than the predetermined threshold value (YES at step 452), the screen control section 17 determines that rainbow banding easily occurs, and selects the screen which minimizes the misregister, for example, the line pattern screen which has 166 lines, a moderate number of lines (at step 453).

In addition, when the object is a specific object (YES at step 451), and the chroma for the object is equal to or higher than the predetermined threshold value (NO at step 452), the screen control section 17 determines that banding easily occurs, and selects the screen which stabilizes the dots, for example, the dot pattern screen which has 106 lines, a low number of lines (at step 454).

On the other hand, when the object is not a specific object (NO at step 451), the screen control section 17 determines that banding is difficult to occur, and selects the ordinary screen, for example, the dot pattern screen which has 212 lines, a high number of lines (at step 455).

As described above, an aspect of the present invention provides an image formation apparatus which receives a job, and forms an image including an object specified with printing data included in the received job, and which includes a job receiving section which receives a job, an image development section which identifies the object to be formed on the basis of the printing data included in the job received by the job receiving section, and an image processing selection section which identifies a tendency of banding occurring in an output image on the basis of a type of the job received by the job receiving section and a type of the object identified by the image development section, and selects an image processing according to the identified tendency.

A second aspect of the present invention is the image formation apparatus according to the first aspect of the invention, in which the image processing selection section may carry out selection of a screen as the image processing.

A third aspect of the present invention is the image formation apparatus according to the first aspect of the invention, in which the image processing selection section may identify a type of banding which occurs, and selects the image processing according to the type of the identified type of banding.

A fourth aspect of the present invention is the image formation apparatus according to the first aspect of the invention, in which the image processing selection section may select the image processing on the basis of a judgement criterion selected from a plurality of judgment criteria according to the type of the job or the type of the object.

A fifth aspect of the present invention is the image formation apparatus according to the first aspect of the invention, in which the image processing selection section may identify the tendency on the basis of at least one of an object attribute, a size, a position, a geometry, a coverage in a region, a chroma, the number of colors, a density, and a resolution as the type of the object

A sixth aspect of the present invention is the image formation apparatus according to the first aspect of the invention, in which the image processing selection section may identify the tendency on the basis of at least one of the number of continuous output sheets, an output speed, and a selected condition of paper as the type of the job.

A seventh aspect of the present invention provides an image processing method for an image formation apparatus which receives a job, and forms an image including an object specified with printing data included in the received job, in which an image processing selection section identifies a tendency of banding occurring in an output image on the basis of a type of the job and a type of the object, and selects an image processing according to the identified tendency.

An eighth aspect of the present invention is the image processing method according to the seventh aspect of the invention, in which wherein the image processing selection section may carry out selection of a screen as the image processing.

A ninth aspect of the present invention is the image processing method according to the seventh aspect of the invention, in which the image processing selection section may identify the type of banding which occurs, and selects the image processing according to the type of the identified banding.

A tenth aspect of the present invention is the image processing method according to the seventh aspect of the invention, in which the image processing selection section may select the image processing on the basis of a judgment criterion selected from a plurality of judgment criteria according to the type of the job or the type of the object.

An eleventh aspect of the present invention is the image processing method according to the seventh aspect of the invention, in which the image processing selection section may identify the tendency on the basis of at least one of an object attribute, a size, a position, a geometry, a coverage in a region, a chroma, the number of colors, a density, and a resolution as the type of the object

A twelfth aspect of the present invention is the image processing method according to the seventh aspect of the invention, in which the image processing selection section may identify the tendency on the basis of at least one of the number of continuous output sheets, an output speed, and a selected condition of paper as the type of the job.

According to the above-mentioned aspects of the present invention, degradation of the image quality due to the occurrence of banding can be prevented, and the ordinary screen can be used for any portion where banding is difficult to occur, thus there is no need for unavoidably lowering the image quality.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-266964 filed on Sep. 14, 2005 including criterion, claims, drawings and abstract is incorporated herein by reference in its entity.

What is claimed is:

1. An image formation apparatus which receives a job, and forms an image including an object specified with printing data included in the received job, comprising:
a job receiving section which receives a job;
an image development section which identifies the object to be formed on the basis of the printing data included in the job received by the job receiving section; and
an image processing selection section which identifies a tendency of banding occurring in an output image on the basis of a type of the job received by the job receiving section and a type of the object identified by the image development section, and selects an image processing according to the identified tendency.

2. The image formation apparatus of claim 1, wherein the image processing selection section carries out selection of a screen as the image processing.

3. The image formation apparatus of claim 1, wherein the image processing selection section identifies a type of banding which occurs, and selects the image processing according to the type of the identified type of banding.

4. The image formation apparatus of claim 1, wherein the image processing selection section selects the image processing on the basis of a judgment criterion selected from a plurality of judgment criteria according to the type of the job or the type of the object.

5. The image formation apparatus of claim 1, wherein the image processing selection section identifies the tendency on the basis of at least one of an object attribute, a size, a position, a geometry, a coverage in a region, a chroma, the number of colors, a density, and a resolution as the type of the object.

6. The image formation apparatus of claim 1, wherein the image processing selection section identifies the tendency on the basis of at least one of the number of continuous output sheets, an output speed, and a selected condition of paper as the type of the job.

7. An image processing method for an image formation apparatus which receives a job, and forms an image including an object specified with printing data included in the received job, wherein
an image processing selection section identifies a tendency of banding occurring in an output image on the basis of a type of the job and a type of the object, and selects an image processing according to the identified tendency.

8. The image processing method of claim 7, wherein the image processing selection section carries out selection of a screen as the image processing.

9. The image processing method of claim 7, wherein the image processing selection section identifies the type of banding which occurs, and selects the image processing according to the type of the identified banding.

10. The image processing method of claim 7, wherein the image processing selection section selects the image processing on the basis of a judgment criterion selected from a plurality of judgment criteria according to the type of the job or the type of the object.

11. The image processing method of claim 7, wherein the image processing selection section identifies the tendency on the basis of at least one of an object attribute, a size, a position, a geometry, a coverage in a region, a chroma, the number of colors, a density, and a resolution as the type of the object.

12. The image processing method of claim 7, wherein the image processing selection section identifies the tendency on the basis of at least one of the number of continuous output sheets, an output speed, and a selected condition of paper as the type of the job.
